(19) United States
(12) Patent Application Publication
(10) Pub. No.: US 2015/0020518 A1
(43) Pub. Date: Jan. 22, 2015

(54) Gravity-Buoyancy Object Turbine

(71) Applicant: V. Manoj, (US)

(72) Inventor: V. Manoj, Trivandrum (IN)

(21) Appl. No.: 14/372,261

(22) PCT Filed: Jan. 9, 2013
(86) PCT No.: PCT/IN2013/000018

§ 371 Date: Jul. 15, 2014

(30) Foreign Application Priority Data
Feb. 29, 2012 (IN) 766/CHE/2012

(51) Int. Cl. F03B 17/02

(52) U.S. Cl. CPC F03B 17/02
USPC 60/495

(57) ABSTRACT

A Gravity-Buoyancy Object Turbine (GBOT) is provided to generate kinetic energy using gravitational force and buoyancy force exist in the nature. The turbine of the invention has a gravity (air) chamber and a buoyancy (liquid) chamber, arranged side-by-side in such a way that both gravity and buoyancy exerts force directly and continuously on the shaft/drum/belt to cause the rotation of the turbine. The turbine blades (objects) forms the shape of a wheel, which enables leak-proof and resistance-free transfer between air and liquid chambers. The objects could be cylindrical and rotating by its own. The material, size and shape of key components and related control mechanisms of GBOT are optimized to deliver maximum performance. Electro-mechanical control system also could be employed to manage the leak-proof and resistance-free transfer of objects between air and liquid chambers

### FIELD OF THE INVENTION

The present invention generally relates to power generation and more particularly, relates to a turbine which makes use of gravity force and buoyancy force to generate kinetic energy.

### BACKGROUND OF THE INVENTION

Nowadays, energy demand is growing voraciously and the major portion of world's energy requirements is met by generating electricity through burning fossil fuels such as coal, natural gas, petroleum, gas and diesel power plants, nuclear power plants and renewable energy sources like hydroelectric power plants, sunlight, wind, tides, geothermal heat and biomass.

The burning of fossil fuels for power generation has serious adverse environmental impact through high carbon emission (causing Greenhouse Effect, considered as the most critical environmental threat faced by our planet today). Further, the reserves of fossil fuels are being depleted much faster. Nuclear power is the use of sustained nuclear fission to generate heat and there by electricity. Nuclear power plants provide about 13-14% of the world's electricity. Building enough nuclear power stations to make a meaningful reduction in greenhouse gas emissions would cost trillions of dollars, create tons of lethal high-level radioactive waste, contribute to further proliferation of nuclear weapons materials, and could result in a Chernobyl/Fukushima-scale accident once every decade. Perhaps most significantly, it will squander the resources necessary to implement meaningful climate change solutions. Hence, a global movement towards the generation of renewable energy is under way to meet increased energy needs.

Hydro-electric power stations produce electrical power through the use of the gravitational force of falling or flowing water. It is the most widely used form of renewable energy. Though this is the most environment-friendly method of large-scale energy generation known today, it has got major disadvantages such as heavy ecosystem damage, loss of land, methane emissions, relocation of people and failure hazard. Also, wrong location chosen for dam construction, siltation, flow shortage etc. making many of the hydro-electric projects inefficient or failure. Earthquakes can also be induced by the dams. Globally, there are over 100 identified cases of earthquakes that scientists believe were triggered by reservoirs.

Climate change concerns, coupled with high oil prices and increasing government support, are driving sources for increasing renewable energy generation. The major renewable energy sources such as windmills and solar plants depend on the availability of land and require heavy initial capital investments. Also the power generated from the same is not consistent, not completely predictable and hence intermittent. This nature of renewable energy sources makes it not to consider as major dependable energy source.

All the above-mentioned drawbacks of the existing methods or systems of electricity generation lead to the need of a kind of energy or power generation system that is completely nature-friendly, consistent, efficient, of low or reasonable capital investment and scalable.

A force exists within nature and going to last till the end of this planet is the gravitational force. It is endless source of energy and nothing adverse happens to the nature if we effectively consume it without disturbing the nature. Hydroelectric plants do it, by making use of the gravitational force of falling or flowing water. However this has got heavy dependency on sunlight and rains and also the hydroelectric plants have many adverse effects as explained in the previous section.

Gravity force and buoyancy force are very powerful, available, reliable, affordable and clean energy sources. Also they are natural, environmental friendly and endless. In the past, there have been attempts to invent a mechanism/technology that generate electricity without the need for any external fuel. Some of such inventions utilize gravity and buoyancy principles to generate power. For example, Chinese Document No. 1831327 to SONG, Indian Patent Appln. No. 189/CHE/2010 to RAJKUMAR, Korean Patent Appln. Nos. 20010089040 to Goo and 20100128103 to MIN, Japanese Document Nos. 51124752 to ETSUO; 2010053850 to KAORU; 3179173 to YOSHIRO; 5044627 to YOSHIRO; 7049078 to TAKASHI; 8061209 to TERUO; 2000240557 to TADASHI; 2003056442 to YASUSHI; 2007023797 to MOTOYO; 2011021589 to YOSHIHIRO; 55109772 to RIYOUJI; 56023571 to YOSHIO; 56115870 to MAKIO; 59096488 to HIROKI and 60056178 to KATSUO, U.S. Pat. No. 4,254,622 to Denson; U.S. Pat. No. 4,718,232 to Willmouth; U.S. Pat. No. 5,944,480 to Forrest; U.S. Pat. No. 7,765,804 to Davis; U.S. Pat. No. 4,242,868 to Smith; U.S. Pat. No. 4,599,857 to Kim; U.S. Pat. No. 4,674,281 to Kim; U.S. Pat. No. 4,720,976 to Kim; U.S. Pat. No. 6,546,726 to Tomoiu; U.S. Pat. No. 6,817,180 to Newman and U.S. Pat. No. 8,011,182 to Hastings, U.S. Pat. Appln. Nos. 20100180587 to Manakkattupadeettathil; 20060042244 to Villalobos; 20060267346 to Chen; 20080092535 to Razack; 20090021016 to McDermott; 20100313563 to Gronback; 20090293472 to Propp and 20100170242 to Irps, PCT Publication Nos. 2001053698 to CHOI et al.; 2002064972 to KINOSHITA; 2005115093 to AKIMOTO; 2006125349 to CHEN; 2007007114 to GILLESPIE; 2007008023 to KIM; 2007030027 to CARREIRA; 2007034502 to NARAYANA; 2011034347 to KWON and 2009076727 to KWOK disclose the use of buoyant force and gravity force for operation.

However, the above mentioned prior art has one or more of the drawbacks including, but not limited to, are: uses buoyant and gravity forces indirectly, not both the forces operating together at any point of time, buoyant force with no direct impact on the rotation, both the forces operating on different shafts, not holding the liquid vertically on one side of the shaft, not effectively pushing the object from air to liquid, no turbine kind of arrangement, object transfer mechanism operating in vertical plane resulting in water column pulling the chain/belt in the opposite direction, no optimal selection of material or mass or shape, no electronic control system, uses one or more liquids as medium, uses a floating cylinder with in a cylinder with a liquid and a pulley system, uses with submerged variable volume vessels, uses compressed gas and piston inserted into cylinder, uses with variable volume bag, uses along with magnetic forces, uses radial gate valves and flap valves, use of hatch assembly to pass the cylinders from one chamber, needs external input or power to pump the water, no generation of rotational movement, uses buoyant piston and cylinder, generates up-down movement but not rotation, very complex, costly, in-efficient and non-scalable. Therefore, a turbine which effectively gets over or simplifies the above hurdles or bottlenecks to realise a large-scale installation is in demand.

### SUMMARY OF THE INVENTION

The present invention relates to a Gravity-Buoyancy Object Turbine (hereinafter called GBOT) which combines gravitational force and buoyancy force to cause the rotation of the turbine.

The aim of the present invention is to provide novel methods to pass the object between the gravity and buoyancy chambers in a horizontal plane with no/minimal leakage of liquid.

According to the present invention, the. GBOT has the ability to hold the water vertically and pass the object from air-chamber to water-chamber by making use of the torque available through gravity and buoyancy force. Hence, the selection of material, mass, volume-of-cavity, total-volume, shape, status of object (fixed or moving) and size of the object are important parameters for optimum performance.

In one embodiment of the invention, the object has a specific mechanical design of exterior and interior shape and parts such as built-in-valves along with a suitable design of the passage tunnel for smooth transfer between chambers in the horizontal plane to minimize gravity effect. Also, objects are designed to form its shape as part of a wheel to minimize friction while passing through the passage tunnel.

In another embodiment of the invention, the GBOT includes a mechanical or electro-mechanical control system such as mechanical/electronic sensors and controllers, gates-valves and actuators which controls and manages the passing of object from gravity chamber to buoyancy chamber.

The present invention provides a Gravity-Buoyancy Object Turbine (GBOT) which combines gravitation force and buoyancy force to cause the rotation of the turbine. Such a turbine can be linked with a generator to produce electricity.

The advantages of the present invention are: (a) getting the gravitational and buoyancy forces act on the same shaft(s)/drum(s)/belt at any point of time on a continuous basis (b) only external supply needed is liquid and the recycling of liquid can also be incorporated (c) simple design (d) scalable (e) suitable for distributed generation needs of micro-grids (f) reliable, continuous source of energy and pollution free energy.

The turbine makes use of gravity force and buoyancy force to generate kinetic energy and employs any or all of the novel methods introduced in this invention.

### BRIEF DESCRIPTION OF THE DRAWINGS

The objective of the present invention will now be described in more detail with reference to the accompanying drawings, in which:

FIG. 1a and FIG. 1b illustrate the fundamental principles behind the operation of GBOT;

FIG. 2 illustrates the particular embodiment of the GBOT which is designed in detail;

FIGS. 3a, 3b, 3c, 3d, 3e, 3f, 3g and 3h illustrate the parts of GBOT in FIG. 2. mentioned above;

FIG. 4a, 4b, 4c, 4d, and 4e illustrate other possible turbine arrangements of the invention;

FIGS. 5a, 5b and 5c illustrate the various proposed designs of the object of other possible turbine arrangements considered in FIGS. 4a to 4e;

FIG. 6 illustrates the implementation of GBOT based on another embodiment of the invention which uses electro-mechanical control system;

### DESCRIPTION OF REFERRING NUMERALS

1—GBOT of the invention
10—Rotating disc with shaft/drum/belt
20—Rotating wheel
30—Gravity chamber
40—Buoyancy chamber
50—Object
60—Chamber separator block
70—Roller
80—Support clamp
90—Glass cover
100—Enclosure
110—Greased (lubricated) metallic surface
120—Sensor
130—Controller

### DETAILED DESCRIPTION OF THE INVENTION

A series of definitions that are provided below shall be used in the subsequent description, both to clarify general concepts, and to specify technical characteristics of specific elements of the invention.

Shaft/Drum/Belt:

The rotating part of the turbine on which the turbine blades are mounted. The movement of the turbine blades due to gravity or buoyancy make this part (shaft or drum or belt-on-pulleys) move/rotate. It shall be connected to generator for generating electricity.

Turbine Blade:

The parts attached to the shaft/drum/belt. The torque applied by the same and the movement/rotation resulted makes the shaft/drum/belt rotate/move. In case of GBOT, turbine blades shall act as weight and float (weight-cum-float) as well.

Weight-Cum-Float:

A specially designed turbine blade, which acts as weight in gravity chamber and acts as float in buoyancy chamber.

Object:

The weight-cum-float or turbine blade or both as per context. In the detailed design of the embodiment, the object is in cylindrical shape.

Gravity Chamber:

The chamber in which the object fall/move from top to bottom due to gravity. Normally this chamber will be open to atmosphere.

Buoyancy Chamber:

The chamber in which the object floats from bottom to the top of the surface of the liquid.

Liquid:

Water. But other liquids can also be considered.

Transfer Mechanism:

The mechanical or electro-mechanical arrangement which manages the transfer of object from gravity chamber to buoyancy chamber with no/minimal leakage of liquid.

Separator Block:

Part of the container body which separates the chambers at the bottom of it and also provides a passage tunnel to pass the object from gravity chamber to buoyancy chamber with no/minimal leakage of liquid.

Passage Tunnel:

Is the tunnel kind of space between separator block and shaft/drum/belt, through which the objects pass to the buoyancy chamber with no/minimal leakage of liquid.

Fundamental Principles Behind the Operation of GBOT

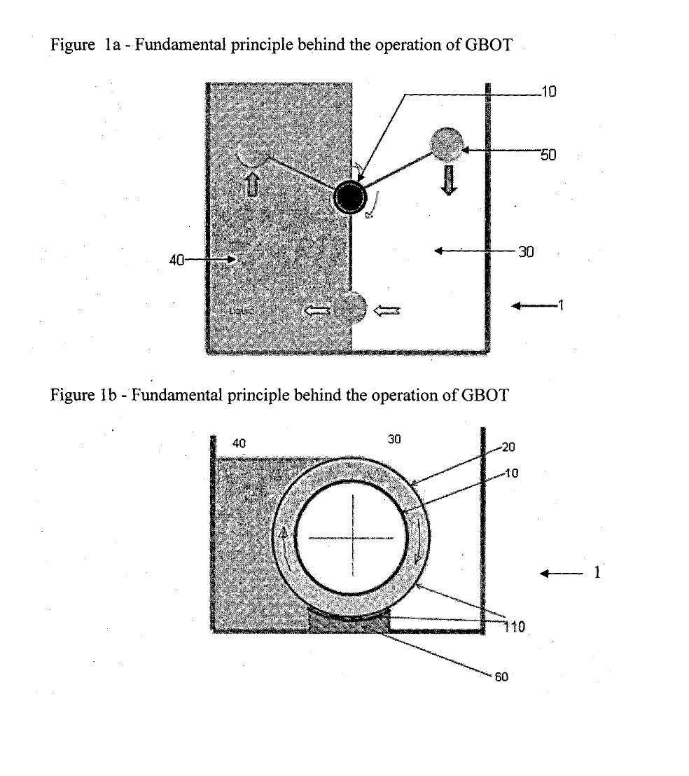

FIG. 1a illustrates the fundamental principle behind the operation of GBOT (1) which use gravity and buoyancy forces to rotate a shaft (10). The gravity force and buoyancy force is in the opposite direction (downward and upward, acting on the opposite sides of the shaft) and ideally the torque applied by them on the shaft should be equal in magnitude to make the shaft rotate at a constant speed. The gravity force depends on the mass of the object while the buoyancy depends on the volume of the object (buoyancy depends on the mass of the water replaced by the object (50)). Hence the mass and volume of the object has to be designed in such a way that both gravity and buoyancy generates same magnitude of force on the shaft (10). Here, the rotation of shaft is achieved by the novel methods of the present invention via holding the liquid vertically on one side of the shaft/drum/belt (10) and pushing the object (50) from the gravity chamber (30) to the buoyancy chamber (40).

FIG. 1b illustrates the rotating wheel (20) provided with liquid on one side and air on other side. The chamber separator block (60) and the rotating wheel (20) together hold the liquid vertically and maintain the liquid chamber and air chamber side-by-side. Assume that an external force rotates the drum/shaft (10) at the centre and there by the wheel. The wheel (20) has a lubricated (greased) metallic outer surface (110) and the separator block (60) also has got a similar surface at the top (both surfaces marked in RED). So, while rotating the wheel (20), the friction between the wheel and the separator block (60) will be minimal. The important point to be noted is that the head of the liquid (liquid pressure) also offering no/minimal resistance to rotation of the wheel due to the fact that the wheel has got only a tangential contact to liquid head while entering liquid chamber. No plane (of the wheel) is directly pushed against liquid pressure to get into and move through the liquid. Thus, the separator block (60) creating a smooth passage tunnel through which portion of the wheel moving to the liquid. The rubber-lining and rollers (70) are also can be employed for smooth (frictionless and leak-free) movement of the wheel-shaped objects through the passage tunnel and appropriately used to make leak proof moving contacts.

Detailed Design of GBOT

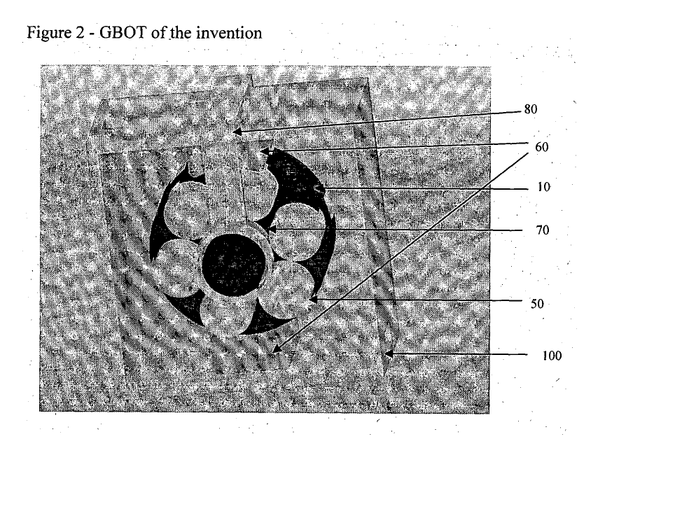

FIG. 2 illustrates the GBOT (1) according to the present invention. The GBOT comprises a disc with shaft (10), a rotating wheel (20), cylindrical objects (50) embedded in the periphery of disc with shaft (10), a chamber separator block (60) placed between the disc with shaft (10) and the enclosure (100) at the top and bottom position, a glass cover (90) mounted on the enclosure (100), rollers (70) placed on the shaft (10) in which the rotating disc is mounted, a clamp (80) used to place the shaft (10) on the enclosure (100). The enclosure (100) may have a rubber beading on which the glass (90) may be mounted to avoid any leakage of water.

In operation with continued reference to FIG. 2, the embedded-cylindrical objects (50) smoothly rotate itself while touching the block (60) at top and bottom position in the transfer mechanism. While one end of the cylinder (50) touches the chamber separator block (60), diagonally opposite edge of the cylinder (50) touches the roller (70) in the shaft (10) and the roller rotates in the opposite direction. There will be two such rollers on either side of the rotating plastic disc (on the shaft in which the rotating disc is mounted). The rollers. (70) shall be free to rotate and rotates when an object gets in contact with it. The gap between the cylinders (50) and the rotating wheel (20) has to be sufficient to hold some water while in water chamber hence it exerts the needed buoyancy force.

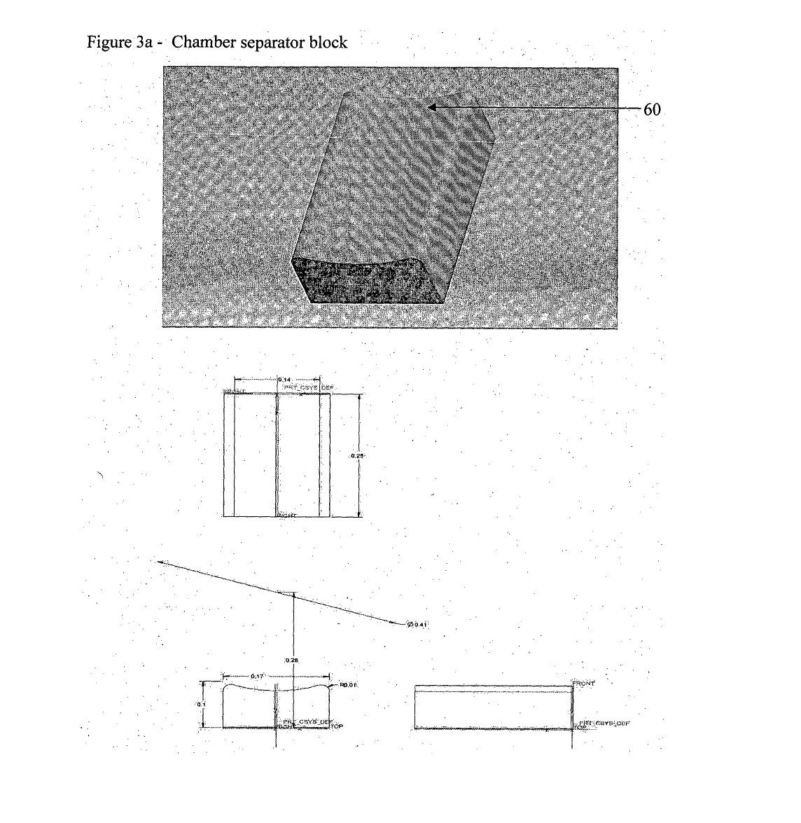

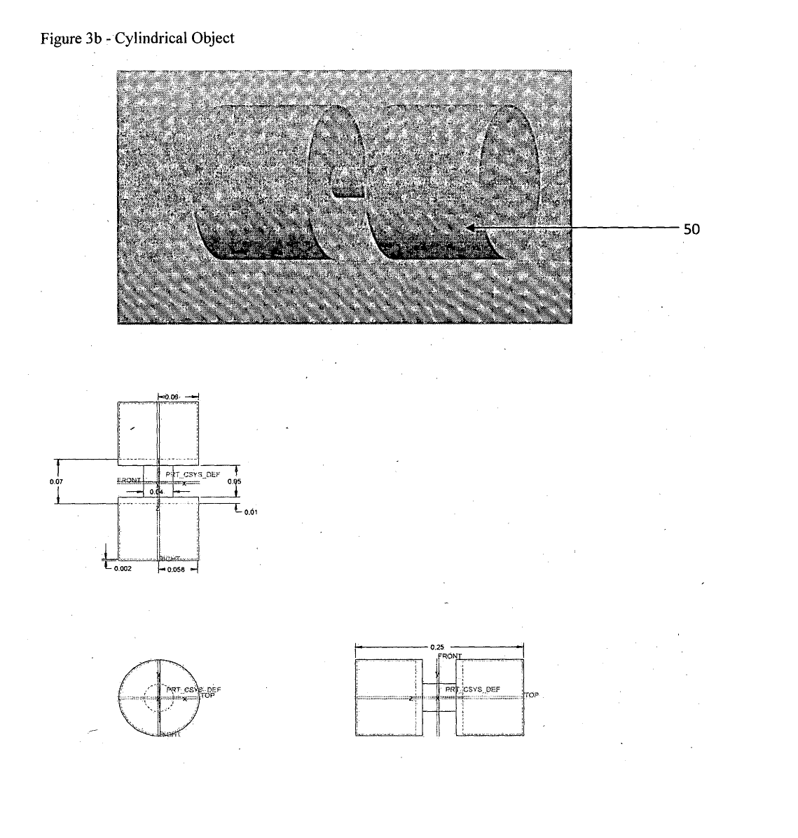

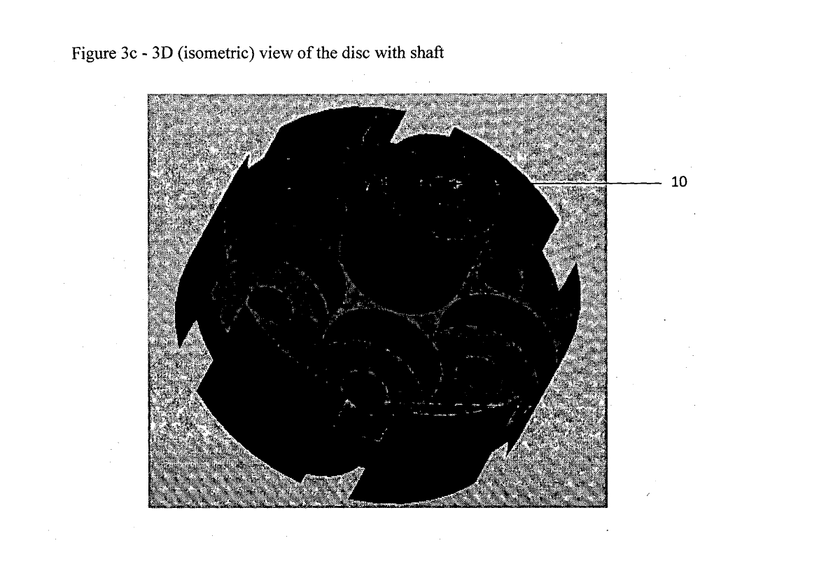

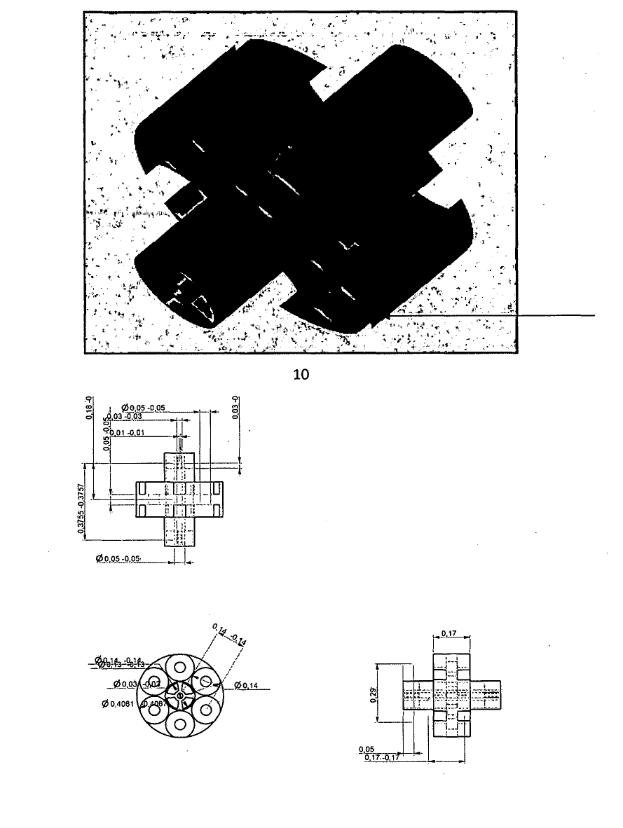

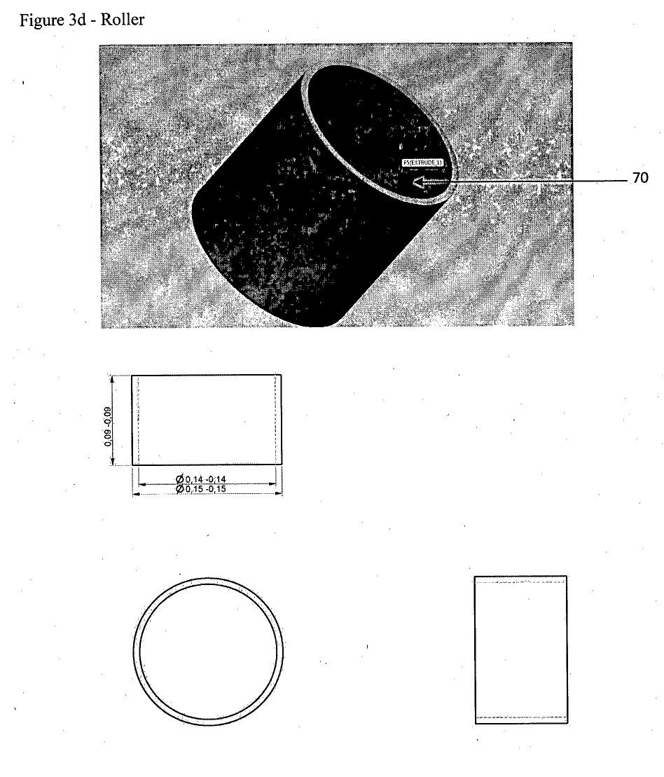

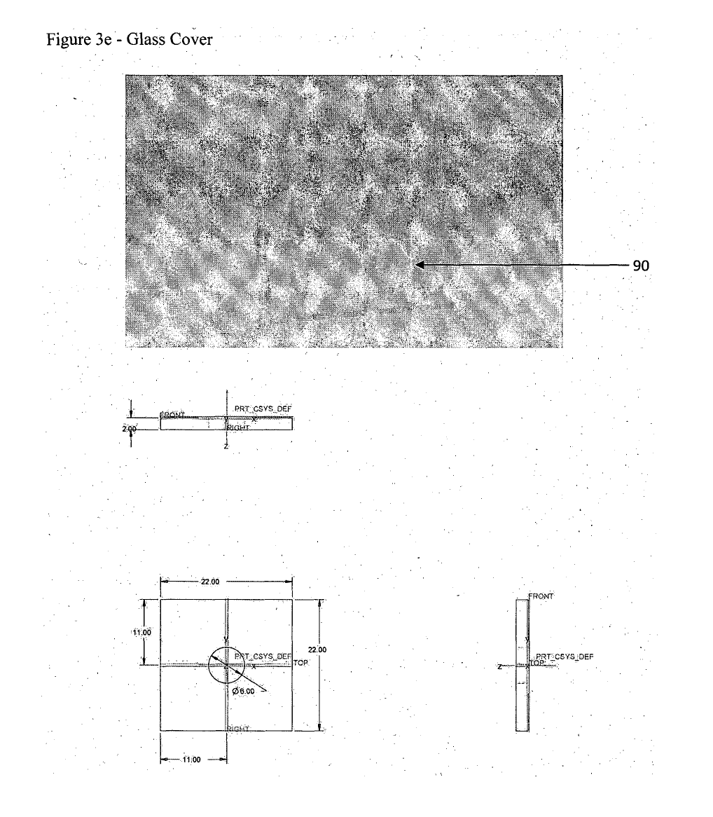

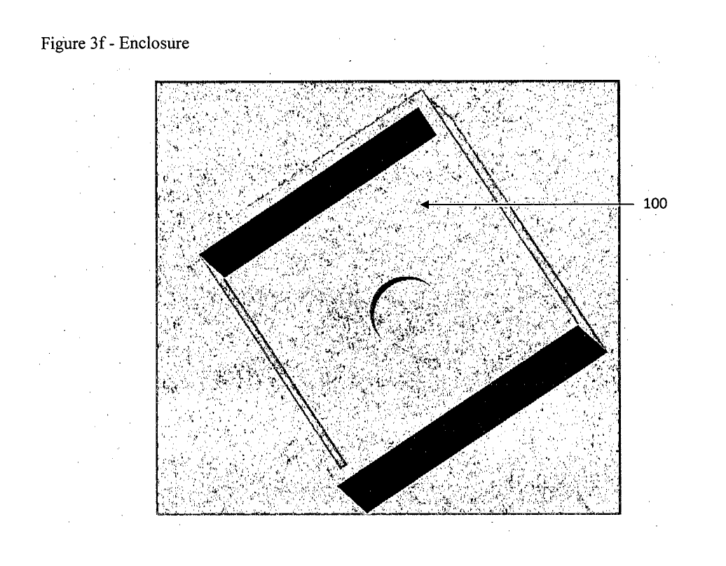

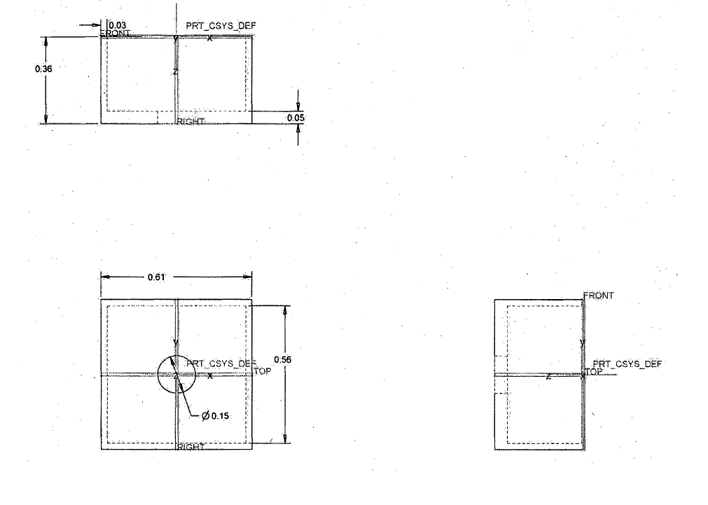

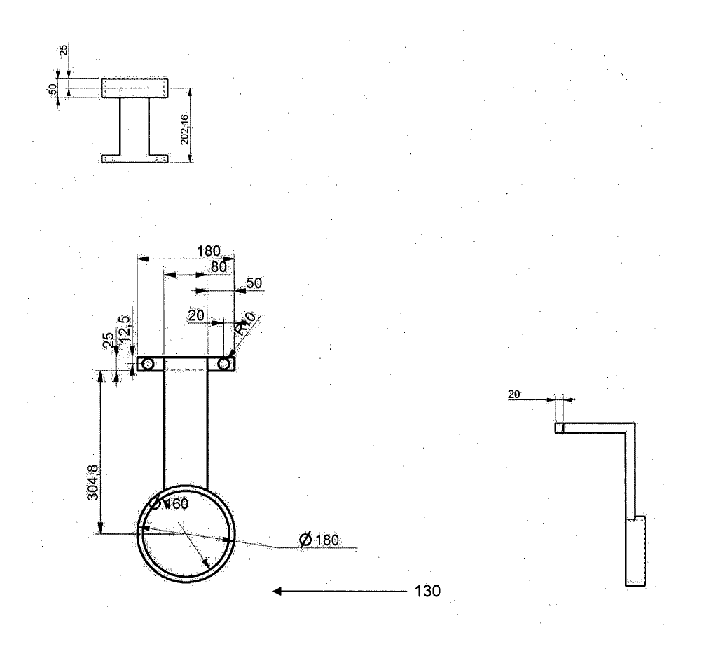

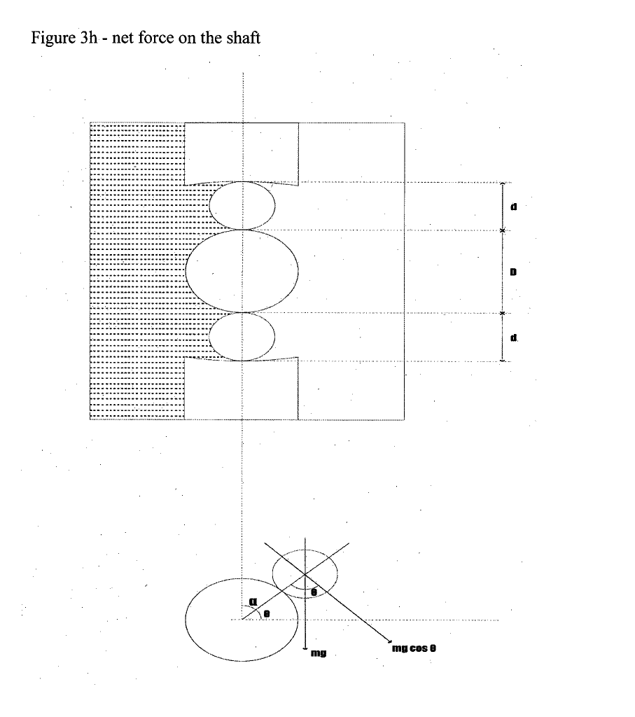

FIGS. 3a, 3b, 3c, 3d, 3e, 3f and 3g illustrate block (60), cylinder object (50), disc with shaft (10), roller (70), glass cover (90), enclosure (100) and support clamp (80) respectively.

In preferred embodiment of the present invention, the selection of the material, mass, volume-of-cavity, total-volume, shape and size of the object are the most critical design parameters for optimum performance. The object can be a cylinder, weight-cum-float or a turbine blade. The material of the object (50) should provide maximum weight for a given volume and shapes to offer maximum possible gravitational force. It should be able to form a cavity which can generate enough buoyancy force to compensate the gravity and also add some upward push when it is in the water chamber: It should be feasible to fabricate and should have enough mechanical strength. Also, it should be easily available, non-toxic and cost effective. When heavy material is selected, the required cavity size will be big (hence the wall thickness will be too low) and it won't be feasible to fabricate and also will not have enough mechanical strength. In case of a lighter material, it can easily be fabricated with sufficient cavity to float (with good wall thickness and hence good mechanical strength), but the gravity force on it will be less. The ratio of volume of cavity (Cv) to total volume of object (Tv) should be less than one. When this ratio becomes closer or equal to one, it will be difficult to fabricate (also will not have enough wall thickness and hence low mechanical strength). When the ratio becomes much less than one, the material is too light and won't generate enough gravity force.

According to the present invention, for operating with water as the liquid, Aluminium is preferred since it is a lighter material and the cavity with-in it can be designed with considerable wall thickness, to provide needed physical strength to operate as envisaged. The calculation, which is the basis for selection of aluminium, is as below:

To have equal (approximately) and opposite forces on both sides of the wheel, buoyancy force should be double of the weight of object.

Let,

Tv=total volume of object

Cv=volume of cavity

Pm=density of the material of blade

Pw=density of water (1000 kg/m3)

Then,

Tv*Pw=2*(Tv−Cv)*Pm

Cv/Tv=(2Pm−Pw)/2Pm

Pm=2700 kg/m3

Hence, Cv/Tv=(2*2700−1000)/2*2700=0.815

Aluminium is considered because it has a Cv/Tv ratio 0.815 which ensures the cavity in the object is to be made with enough wall thickness. Thus, the cavity is made on the vane symmetrically in such a way that Cv/Tv ratio is 0.815.

The density and Cv/Tv ratio calculated for aluminium and other materials are provided in the table below:

| Material | Density Kg/M3 | Cv/Tv |
|---|---|---|
| Lithium | 535 | 0.06542 |
| Wood | 700 | 0.28571 |
| Potassium | 860 | 0.41860 |
| Sodium | 970 | 0.48454 |
| Plastics [Approx.] | 1175 | 0.57447 |
| Magnesium | 1740 | 0.71264 |
| Berylium | 1850 | 0.72973 |
| Silicon | 2330 | 0.78541 |
| Aluminium | 2700 | 0.81481 |
| Diamond | 3500 | 0.85714 |
| Titanium | 4540 | 0.88987 |
| Selenium | 4800 | 0.89583 |
| Vanadium | 6100 | 0.91803 |
| Antimony | 6,690 | 0.92526 |
| Zinc | 7,000 | 0.92857 |
| Chromium | 7,200 | 0.93056 |
| Manganese | 7,325 | 0.93174 |
| Tin | 7,310 | 0.93160 |
| Iron | 7,870 | 0.93647 |
| Niobium | 8,570 | 0.94166 |
| Cadmium | 8,650 | 0.94220 |
| Cobalt | 8,900 | 0.94382 |
| Nickel | 8,900 | 0.94382 |
| Copper | 8,940 | 0.94407 |
| Bismuth | 9,750 | 0.94872 |
| Molybdenum | 10,220 | 0.95108 |
| Silver | 10,500 | 0.95238 |
| Lead | 11,340 | 0.95591 |
| Thorium | 11,700 | 0.95726 |
| Rhodium | 12,410 | 0.95971 |
| Mercury | 13,546 | 0.96309 |
| Tantalum | 16,600 | 0.96988 |
| Uranium | 18,800 | 0.97340 |
| Tungsten | 19,300 | 0.97409 |
| Gold | 19,320 | 0.97412 |
| Plutonium | 19,840 | 0.97480 |
| Platinum | 21,450 | 0.97669 |
| Iridium | 22,420 | 0.97770 |
| Osmium | 22,570 | 0.97785 |

From the above table, it is clear that there are many other materials such as Berylium, Silicon, Diamond are suitable but aluminium is chosen due to its availability, low price and easiness in machining. There could be better suited alloys which can be used for fabricating the object.

In further aspect of the present invention, the shape of the object and the rotating disc on the shaft are designed in such a way that the objects are embedded in the rotating wheel in order to leave minimal gap between the wheel and the transfer mechanism. Preferably, a cylindrical 355 shaped object is selected. This cylindrical shape gives tremendous advantages over other shapes. It is designed such that it rotates within the wheel while passing through the Transfer Mechanism (air to water and water to air). This rotation of cylinder will drastically nullify the effect of friction. The Object, as shown in the FIG. 3b, has two hollow cylinders connected together. The shaft connecting the cylinders will be inside (inserted) in the holes in the rotating disc.

For a typical design, properties of the object proposed are as following:

Density=2700 kg/m̂3

Volume of solid part=4.7725976*ê(−4)m̂3

Total volume (including cavity)=2.67703*ê(−3)m̂3

Mass, m=1.2886 kg

For arbitrary position of vane, the useful force is the net force that acts tangential to the surface of drum/shaft/disc. Let the object is inclined at an angle θ with the horizontal, then useful tangential force, F=mg cosθ. (shown in FIG. 3h)

Considering a pair of diametrically opposite objects, net torque,

T=mg cosθ*distance

But total distance between two objects is D+d/2+d/2

where, D=diameter of centre shaft

d=diameter of vane

Thus, T=mg cosθ*(D+d)

The torque acts and turns the cylinder through an angle dθ

Useful work done, dw=T*dθ=mg(D+d) cosθ dθ

for one rotation, w=∫ mg(D+d) cosθdθ (from 0 to 2π)

work done, w=mg(D+d)*(4) =4 mg(D+d)

Other Proposed Designs/Ideas

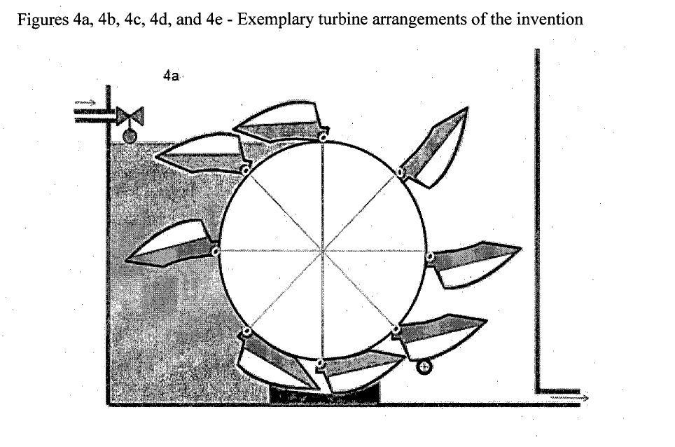

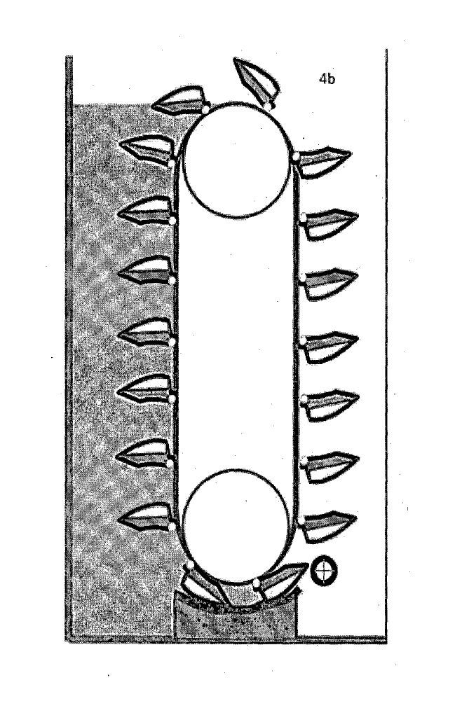

FIGS. 4a, 4b, 4c and 4e illustrate the other possible turbine arrangements of the present invention. In these, if the turbine blades (50) can form/shape itself as part of a wheel (20), it can smoothly enter into buoyancy chamber (40) just like a wheel. In FIG. 4d, a special design of transfer mechanism is shown. It is employed to suite the transfer of piston-cylinder arrangement instead of other type of objects. Each of the turbine blade (50) can be made up of multiple sub modules and collapsible or expandable as needed. Before entering into the passage tunnel provided by the separator block (60), the turbine blade (50) can get collapsed or combined to form the shape of a wheel. After passing into the buoyancy chamber (40), it will get expanded by buoyancy/gravity force to exert maximum torque on the rotating shaft/drum/belt (10).

When the ‘wheel like’ shape is formed by the objects, (50), there can be gaps (shown in FIGS. 4a, 4b, 4c and 4e) between two objects. In such a scenario, there can be valves (shown in FIG. 4e) to resolve the water hammer effect if there is space between the objects when it reaches the bottom of the turbine. The valve can permit the liquid to flow to the gap between objects when high pressure difference exist between them (maximum head is available across the valve). This provision can fill the gap between objects with water and the water hammer effect can be avoided when the second object gets exposed to liquid before it gets into the buoyancy chamber (40). Also, when the valve is in open condition, it reduces the pressure/resistance against the object (50) which moves into the liquid chamber (40).

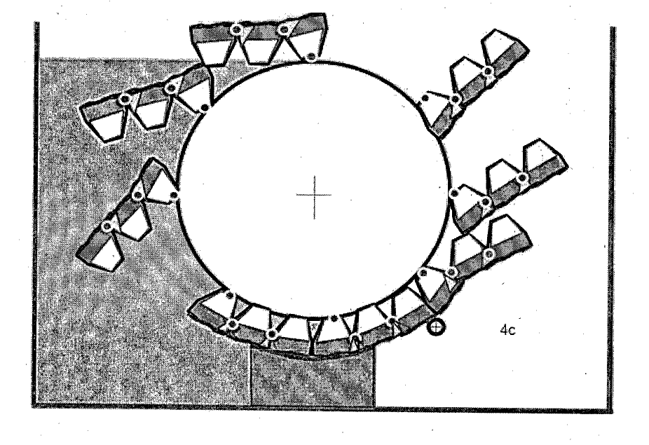

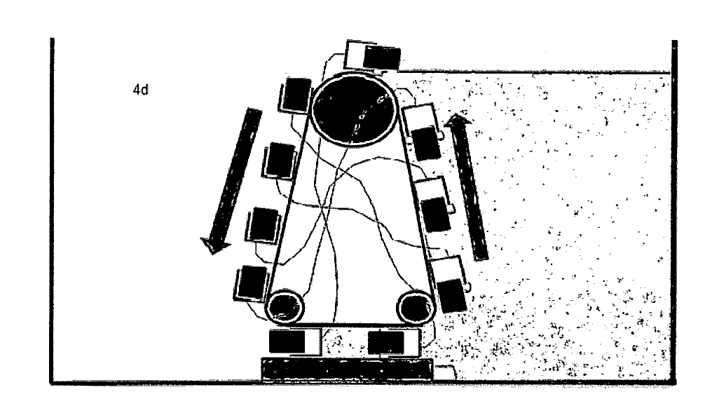

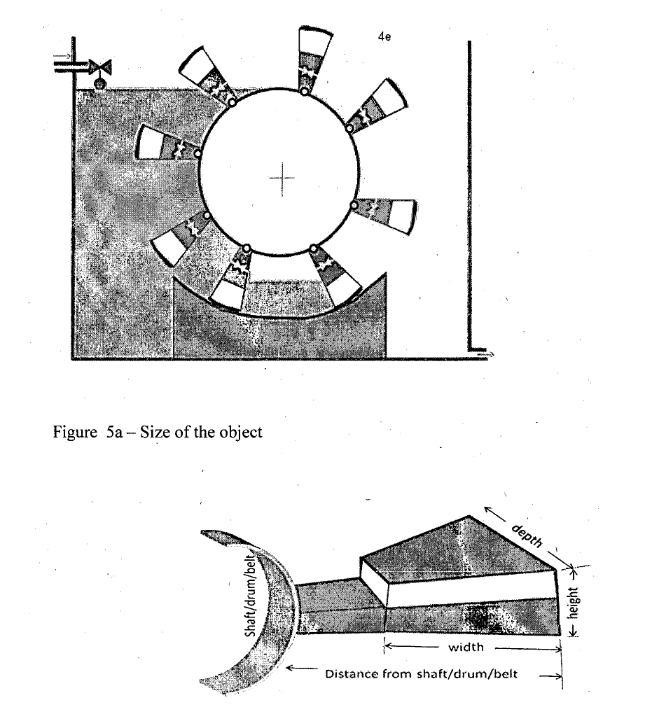

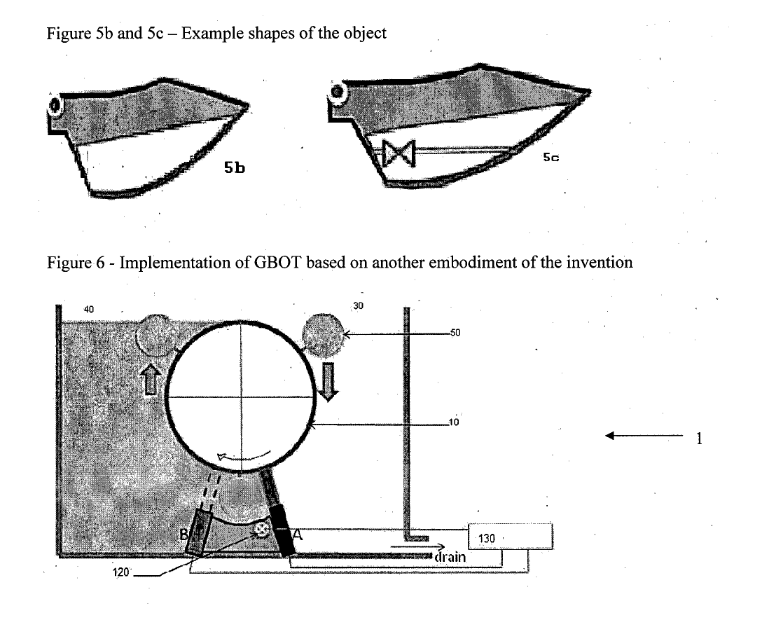

Referring to FIG. 5a, the size of the object in a three dimensional view is depicted. It shows width, height and depth of the cross section of the object (50). The depth of the object and the length/distance from the shaft/drum/belt (10) are other key parameters which increases the torque due to gravity or buoyancy force and hence are to be considered while designing the object.

The shape of the object has to be made in such a way that it should float in the liquid due to buoyancy force equal to the gravitational force experienced by the body in air. It should encompass vacuum/air/gas to have enough volume to displace water volume of mass equivalent to the weight of it in air. FIG. 5b and FIG. 5c illustrates the example designs of the object with and without in-built valves, respectively.

FIG. 6 illustrates the operation of GBOT (1) based on another embodiment of the present invention. This is an innovative method for managing the entry of the weight-cum-float (50) to the buoyancy chamber (40) by mechanically/electronically controlling the gates. The weights/floats (50) are mounted on the drum/shaft/belt (10) with enough distance between them. It is important to have this distance, which is required to provide the time to have the valves operated as needed. In FIG. 6, the weights/floats are mounted at 120 degree apart is shown.

Consider an initial condition of gate A as open and gate B as closed. The controller detects the position of the object using an electronic/mechanical proximity sensor (120) when it reaches the space between the gates. Upon detecting the same, the controller (130) will close gate A and open gate B, permitting the liquid to fill the space between the gates and permits the object to get into the space between both gates. Already opened gate B will be permitting the object to move to the buoyancy chamber (40). As soon as the object (50) moves to the buoyancy chamber (40), gate B will be closed and gate A will be opened. Both gates will remain in the same condition till next object enters the space between the gates. And then the operation will be repeated. The entire operation (i.e. sensing the object's position and operating the valves with needed precision and timing) shall be managed by the mechanical/electronic controller (130).

There can be a liquid supply line and a float valve connected to maintain the liquid level in the buoyancy chamber (40) to compensate the liquid loss during rotation of the turbine. Also, there needs to be a vent to release the liquid leaked through the transfer mechanism. The entire mechanism can be assembled to have a sealed unit which is connected to a liquid pipe line and a provision for connecting drain.

The functioning of GBOT can be improved by the following features:

(i) Rubber lining/coating: In the present invention, friction between the rotating cylinders (objects) and the blocks shall be minimal due to the capability of objects to rotate by itself. However, there could be a possibility of objects slipping over the blocks while moving over it. To avoid this, rubber lining/coating is recommended on the blocks, cylinder and the roller.

This rubber lining/coating not only establishes better grip between them and minimises the gaps between them and hence reduces the possible leakage.

(ii) Creation of low pressure region at water chamber: Assume that the object transfer mechanism from water chamber to air chamber is perfect. Means no or very minimal leakage of water to air chamber or air to water chamber happens through the top-transfer mechanism. In such a scenario, a low pressure region (low compared to atmospheric pressure) could be created over the water column in the water chamber. This could reduce the water pressure at the bottom-transfer mechanism and could reduce the water leakage further.

(iii) Recycling of leaked water: As in any similar systems, there will be leakage of water from water chamber to air chamber and hence a recycling mechanism to be considered (a pump and piping is needed to take the water from the exit to the top of water chamber. In FIG. 2, holes are shown in the enclosure at the water entry and exit points). If an effective recycling mechanism is established, GBOT can keep functioning just by adding water to compensate the water loss due to evaporation.

(iv) Leakage free mounting arrangements: Appropriate mechanisms like rubber bushes/beading can be used to mount the shaft on clamp and clamp on enclosure etc.

The advantages of the present invention are: (a) getting the gravitational and buoyancy forces act on the same shaft(s)/drum(s)/belt, at any point of time, on a continuous basis (b) only external supply needed is liquid (e.g. water), to compensate the liquid loss and recycling of liquid can also be incorporated (c) simple design, can be made sealed, compact and portable (d) scalable to address small to medium to large scale applications (e) suitable for distributed generation needs of micro-grids as envisaged in the scenario of Smart Grid (f) GBOT shall be a reliable continuous source of energy, pollution free (runs without using any fuel) and hence a green energy generator preventing the global warming.

While the foregoing written description of the invention enables one of ordinary skill to make and use what is considered presently to be the best mode thereof those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A gravity-buoyancy object turbine (GBOT) for generating kinetic energy continuously by using gravity and buoyancy and without use of any external fuel, comprising:
a rotating disc/shaft/belt;
objects forming the shape of a rotating wheel to easily pass between the chambers;
a gravity chamber and a buoyancy chamber arranged side-by-side;
Object transfer mechanism/provision for smooth transfer of objects between chambers; and
provision for recycling of liquid.

2. The GBOT according to claim 1, wherein said gravity chamber and said buoyancy chamber are arranged side-by-side in a horizontal plane such a way that both gravity and buoyancy exerts force directly and continuously on said disc/shaft.

3. The GBOT according to claim 1, wherein said gravity chamber is an air chamber and said buoyancy chamber is a liquid chamber.

4. The GBOT according to claim 1, wherein said objects are turbine blades.

5. The GBOT according to claim 4, wherein said turbine blades are shaped to a rotating wheel-like part for leak-proof and resistance-free transfer from said gravity chamber to said buoyancy chamber and vice versa.

6. The GBOT according to claim 4, wherein said turbine blades are cylindrical and embedded within the disc forming part of the said rotating disc (wheel).

7. The GBOT according to claim 1, wherein said cylindrical objects rotate within said wheel while passing from said gravity chamber to said buoyancy chamber and vice versa.

8. The GBOT according to claim 1, further comprising appropriate mechanism to pass the said objects with no/minimum leakage of liquid between the said chambers.

9. The GBOT according to claim 1, wherein said object includes specification selectable to exert enough gravity force, buoyancy force, leak-proof, resistance-free and transfer of the object from said gravity chamber to said buoyancy chamber and vice versa.

10. The GBOT according to claim 9, wherein said specifications are size, material, interior and exterior shape, mass and volume of said object.

11. The GBOT according to claim 3, wherein said liquid is water and said object is made of Aluminium material

12. The GBOT according to claim 10, wherein said object includes a cavity.

13. The GBOT according to claim 10, wherein said object has ratio of volume of cavity (Cv) to total volume of object (Tv) should be less than one.

14. The GBOT according to claim 1, further providing rubber lining and coating on parts to ensure friction for rotation as well as to reduce the leakage.

15. The GBOT according to claim 1, further comprising specific mechanical designs including a greased metallic surface and built-in valves along with a suitable design of the passage tunnel (transfer mechanism).

16. The GBOT according to claim 1, further providing net force acting tangentially to the surface of the said disc with shaft.

17. The GBOT according to claim 1, further including an electro-mechanical control system that comprises sensors, valves, actuators and a controller.

18. The GBOT according to claim 17, wherein said electro-mechanical control system controls and manages the passing of the object from said gravity chamber to said buoyancy chamber and vice versa.

19. The GBOT according to claim 1, wherein said buoyancy chamber includes a low pressure region on top of the liquid column.

20. The GBOT according to claim 1, wherein said GBOT employs liquid recycling.

21. The specific design of gravity-buoyancy object turbine (GBOT) for generating kinetic energy continuously without use of any external fuel, comprising:
a rotating disc with shaft at centre;
cylindrical objects embedded in the periphery of said disc shaft, said objects rotate itself;
a gravity chamber;
a buoyancy chamber;
chamber separator blocks placed between the said disc with shaft and an enclosure, at the top and bottom position;
a roller placed on said shaft in which the rotating disc is mounted;
a clamp to position the shaft on said enclosure; and
a glass cover mounted on said enclosure;
said enclosure with liquid entry and exit pipes for recycling.
